(19) United States
(12) Patent Application Publication
(10) Pub. No.: US 2009/0082926 A1
(43) Pub. Date: Mar. 26, 2009

(54) Safety system for seat belt securement

(76) Inventor: Larry W. Klein, Garden Plain, KS (US)

Correspondence Address: THE INVENTORS NETWORK, INC., 332 ACADEMY STREET, CARNEGIE, PA, 15106, US

(21) Appl. No.: 11/903,552

(22) Filed: Sep. 24, 2007

(51) Int. Cl. B60R 21/01; G01G 19/12

(52) U.S. Cl. 701/45

(57) ABSTRACT

A automotive vehicle safety system for seat belt securement that prevents the transmission from being engaged until all seated occupants have buckled their seat belts includes a weight sensing pad for each seat cushion interconnected in circuit to a buckle switch in each seat belt buckle with the buckle switches electrically interconnected to a solenoid that allows or disallows transmission engagement such that if each weight sensing pad detects no weight upon the seat the corresponding buckle switch stays open but when any weight sensing pad detects a predetermined weight (the weight of the occupant upon the seat) that weight sensing pad opens the circuit thereby causing the corresponding buckle switch to close only after that seat belt is buckled thus causing the solenoid interconnected to the transmission to close and enabling access to the transmission so that the vehicle can be shifted out of the parking gear.

### FIELD OF THE INVENTION

The present invention pertains to automotive vehicle safety and monitoring systems, and more particularly pertains to a seat belt safety system that prevents vehicle movement until all passengers have buckled their seat belts.

### BACKGROUND OF THE INVENTION

Automotive vehicle safety systems have expanded exponentially in recent years. With the widespread use of computer microprocessors and micro circuitry continuous monitoring of everything from tire pressure to battery voltage and interior temperature and air conditions can be undertaken. In addition, improved materials and the widespread use of air bags have increased vehicle safety and reduced injuries and deaths due to vehicular accidents.

Nonetheless, the most effective and common vehicle safety system is the across the lap and three point seat belt. Since its inception in the 1960s and 1970s, countless lives have been saved. However, it is still a struggle to get vehicle occupants to use their seat belts. While numerous states mandate seat belt use for both adults and children, enforcement has always been difficult and problematic. Thus, it is desirable to interconnect the use of the seat belt with the ability to engage the vehicle as a method to constrain seat belt use.

Thus, the prior art includes a wide variety of safety and monitoring systems. For example, the Blinkilde et al. patent (U.S. Pat. No. 3,859,485) discloses an occupant sensor seat switch for sensing the presence of a passenger in an automotive vehicle seat that includes pressure sensitive pads disposed within the seats that are interconnected to pressure switches.

The Prachar et al. patent (U.S. Pat. No. 5,426,415) discloses a breath analyzer for use in automobile ignition locking systems for preventing operation of the vehicle should the analyzer detect that the driver is intoxicated.

The Brandin patent (U.S. Pat. No. 5,927,752) discloses an apparatus and methods for determining seat occupant parameters prior to development of an automobile airbag such as location by a vector sensing device located in front of the occupant.

The Sohege et al. patent (U.S. Pat. No. 6,075,444) discloses an arrangement for blocking the operation by an intoxicated operator of a vehicle or machine and which includes a blood alcohol measuring apparatus connected to an evaluation unit interconnected to the vehicle.

The Kuboki et al. patent (U.S. Pat. No. 6,345,839 B1) discloses a seat fitted with seating sensors for calculating various physical characteristics of the occupant in order to determine whether the occupant is a human or an object.

The Aoki patent (U.S. Pat. No. 6,382,667 B1) discloses a passenger restraining protective apparatus that detects the presence of a child on the seat for prohibiting the deployment of an air bag even in the case of a vehicle collision.

The Norton patent (U.S. Pat. No. 6,820,896 B1) discloses a seat occupant weight sensing system that includes load cells distributed throughout the seat and which are in electrical interconnection to a microprocessor that evaluates the amount of force applied to the load cells to determine the weight of the person.

Nonetheless, despite the ingenuity of the foregoing devices and systems there remains a need for a seat belt safety system that allows for the ignition of the automotive vehicle but not its movement until all seat belts for all individuals have been buckled.

### SUMMARY OF THE INVENTION

The present invention comprehends a safety system for seat belt securement that constrains all the occupants of the seats of an automotive vehicle to buckle their seat belts before the vehicle's transmission can be engaged for forward or rearward movement. The safety system of the present invention allows the individual to start the vehicle so that the fan, heater or air conditioner can be turned on as needed, but the safety system doesn't allow for transmission access until all seated occupants have buckled their seat belts.

The safety system of the present invention includes a weight sensing pad disposed within the seat cushion of each seat of the automotive vehicle. The weight sensing pad can include load cells responsive to weight being applied to the seat and a microprocessor or micro circuitry interconnected thereto for actuation in response to the sensing of weight (the seated occupant) on the seat. Disposed within each seat buckle is a seat buckle switch that is normally open but closes when the seat is buckled, and each seat buckle switch is electrically interconnected to each corresponding weight sensing pad. All the seat buckle switches are electrically interconnected to a solenoid that is in electrical connection with the transmission for allowing or disallowing access to the transmission dependent upon whether or not all occupants of the vehicle seats have buckled their seat belts. The safety system includes at least a three minute delay to allow for such things as the vehicle ignition being turned on and then off or to allow for removal of the seat belts for accident and emergency situations. In addition, the safety system is designed so that all the seated occupants must buckle the seat belts before transmission access is allowed and enabled. If, for example, three occupants of the seats have buckled their seat belts but one occupant hasn't, then the solenoid will not allow access to the vehicle's transmission so that forward or reverse movement can occur.

It is an objective of the present invention to provide a safety system for seat belt securement that prevents the vehicle from being engaged until all occupants have buckled their seat belts.

It is another objective of the present invention to provide a safety system for seat belt securement that allows the driver to start the vehicle while in the park gear so that the vehicle interior can be cooled or warmed but prohibits vehicle engagement until the seat belts have been buckled.

It is still yet another objective of the present invention to provide a safety system for seat belt securement that may be sold as an after market product or factory installed.

It is a further objective of the present invention to provide a safety system for seat belt securement that is designed to save lives and reduce automotive insurance costs.

A further objective of the present invention is to provide a safety system for seat belt securement that compels individuals that habitually forget to buckle their seat belts to buckle their seat belts.

A still further objective of the present invention is to provide a safety system for seat belt securement that facilitates compliance with state laws that require that seat belts be used for all vehicle occupants.

These and other objects, features, and advantages will become apparent to those skilled in the art upon a perusal of the following detailed description read in conjunction with the accompanying drawings and appended claims.

### BRIEF DESCRIPTION OF THE DRAWINGS

FIG. 1 is a perspective view of the safety system for seat belt securement illustrating the disposition of a weight sensing pad within a seat cushion of each automotive vehicle seat;

FIG. 2 is a front elevational view of the safety system for seat belt securement illustrating the disposition of the seat buckle switch within the seat belt latch for one automotive vehicle seat;

FIG. 3 is a schematic representational view of the safety system for seat belt securement illustrating the disposition of the system when the seat belt is not buckled and transmission access is disabled;

FIG. 4 is a schematic representational view of the safety system for seat belt securement illustrating the disposition of the system when an occupant of a seat has been detected by the weight sensing pad and the seat belt has been buckled thereby enabling transmission access;

FIG. 5 is a representative flowchart of the safety system for seat belt securement illustrating the steps for engagement of the system for an automotive vehicle having at least four occupant seats; and

FIG. 6 is a representative flowchart of the safety system for seat belt securement illustrating the particular switching states that occur for the seat buckle switch and the solenoid responsive in response to the weight sensing pad sensing or not sensing that any particular vehicle seat is being occupied or is unoccupied.

### DETAILED DESCRIPTION OF THE PREFERRED EMBODIMENT

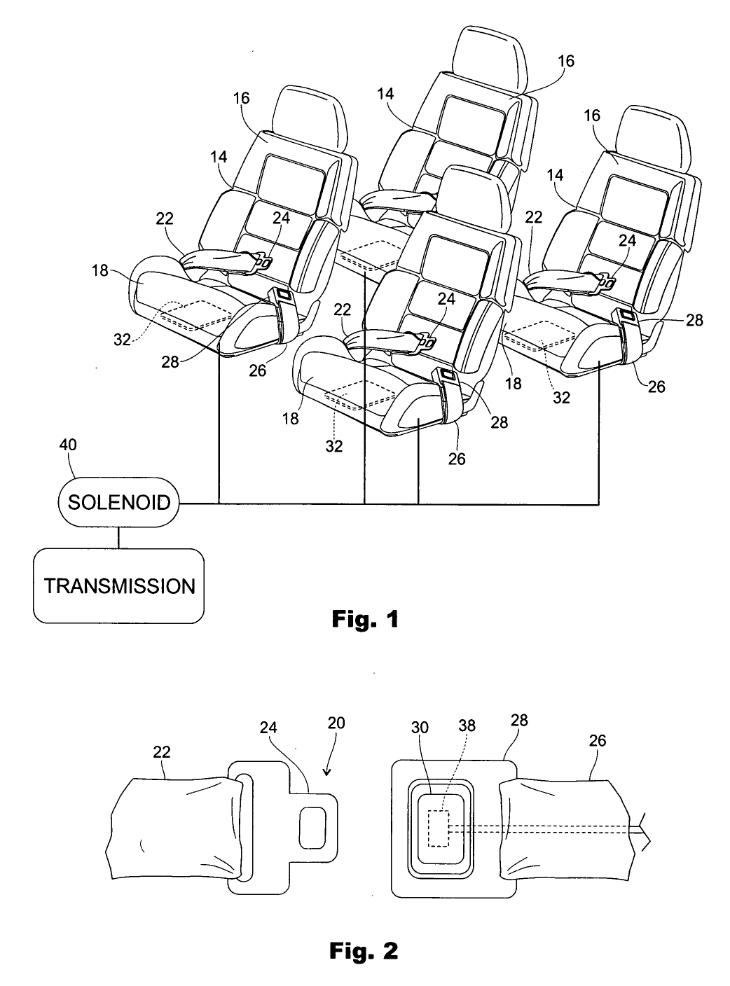

Illustrated in FIGS. 1-6 is a safety system 10 for seat belt securement for an automotive vehicle that enables or disenables access to the transmission 12 dependent on whether the occupants of the automotive vehicle all have buckled their seat belts. The safety system 10 of the present invention allows the driver to start the ignition of the vehicle so that passengers/occupants can use the heater and air conditioner to warm or cool the interior of the vehicle, but prohibits access to the transmission 12 so that the automotive vehicle remains in the park gear until all seat belts have been buckled. The safety system 10 is further designed so that if all seated occupants but one have buckled their seat belts, the occupant whose seat belt remains unbuckled will prevent access to the transmission 12 and thus prevent vehicle movement.

Thus, shown in FIGS. 1, 3 and 4 are representative automotive vehicle car seats 14 (four total) with each seat 14 including a seat back 16 and a seat rest or seat cushion 18. Extending across the seat rest 18 is a seat belt 20 that can be buckled and unbuckled and which includes two portions: a first flexible strap 22 that terminates with an insertion tongue 24 and a second flexible strap 26 that terminates with a buckle 28 that includes a receiving slot (not shown) for the insertion of the tongue 24 therein for buckling the seat belt 20. Each seat buckle 28 includes a manual release button 30 for releasing the insertion tongue 24 so that the seat belt 20 can be unbuckled.

As shown in FIGS. 1, 3, 4, and 6, a plurality of weight sensing pads 32 with one pad 32 being located within one seat cushion 18, and each weight sensing pad 32 includes a weight sensing means for determining whether an occupant/passenger is situated upon the seat cushion 18 of the vehicle seat 14. The weight sensing means of the present invention includes weight sensors 34 such as load cells that are distributed throughout the weight sensing pad 32. For the representative vehicle seating arrangement shown in FIG. 1, four weight sensing pads 32 are used with one weight sensing pad 32 for each vehicle seat 14. In addition, enclosed within each weight sensing pad 32 is a microprocessor 36 for actuating certain actions hereinafter further described responsive to the sensing of the weight of the occupant upon the respective vehicle seat 14 and pad 32. The weight sensors 34 are electrically interconnected to the microprocessor 36.

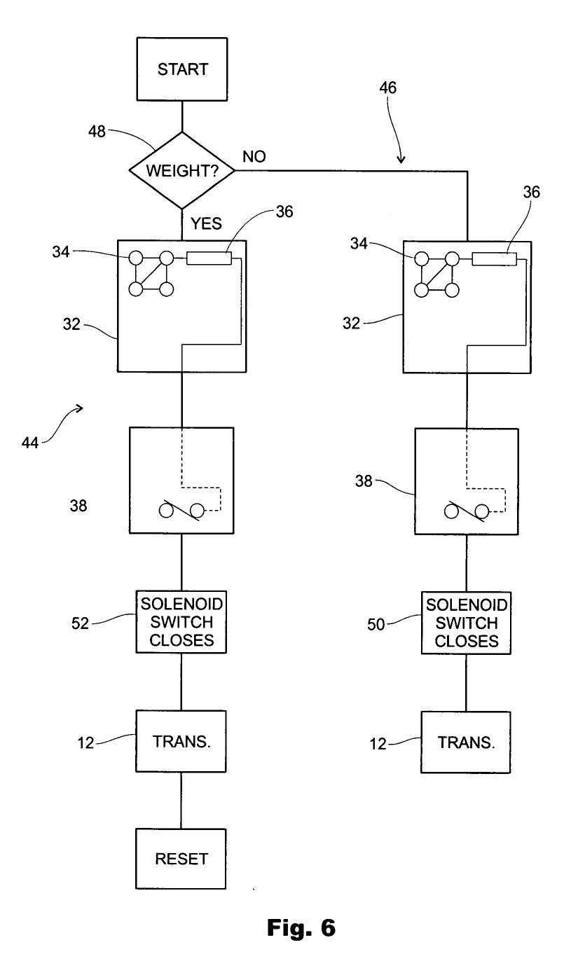

As illustrated in FIGS. 2 and 6, the safety system 10 also includes a plurality of seat buckle switches 38 with each seat buckle 28 having one seat buckle switch 38 contained therein. The seat buckle switches 38 are disposed in either a switch open state or a switch closed state responsive to the occupant buckling or leaving the seat belt 14 unbuckled. Mounted in electrical interconnection with the vehicle transmission 10, and also electrically interconnected to all of the seat buckle switches 38, is a solenoid 40. Depending upon the state—either open or closed, unbuckled or buckled—of all the seat buckle switches 38, the solenoid 40 is disposed to either allows access to the transmission 12 (access enabled), or deny access to the transmission 12 (access disabled).

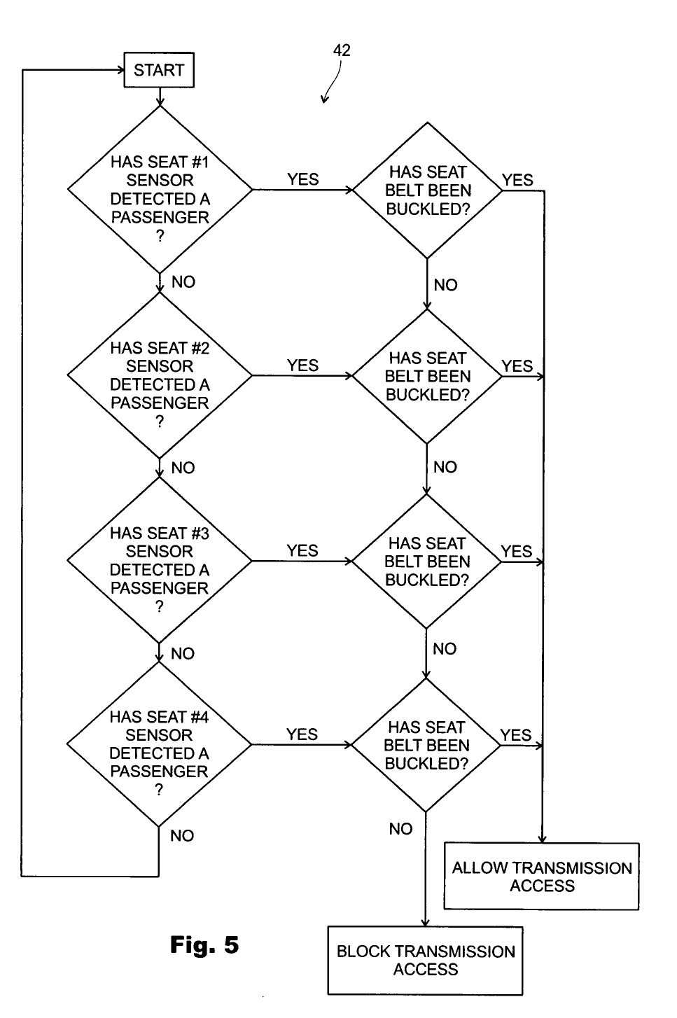

FIGS. 5 and 6 illustrate in flowchart and schematically the operation of the safety system 10. With reference to the flowchart 42 shown in FIG. 5, the sequence of operations commences with each weight sensing pad 32 responsive to whether or not a weight has been placed upon it, i.e., detection that the vehicle seat 14 has an occupant. For a vehicle with four seats, such as the representative vehicle seat arrangement shown in FIG. 1, the sensing process would proceed in sequence, and if no occupants were detected upon any of the seats 14, no action would result. On the other hand, if the weight sensing pads 32 for the respective seats 14 sensed a weight thereupon, the next step would be to determine whether or not that seat buckle switch 38 has been actuated by buckling the seat belt 20. For any occupied vehicle seat 14 the aforestated answer must be yes to allow for access and enablement of the vehicle transmission 12. In order to complete the circuit, as will be hereinafter described, the seat belts 20 for all occupied seats 14 must be buckled, and when that is done the solenoid 40 is actuated to allow and enable access to the transmission 12 so that the vehicle can be put in motion.

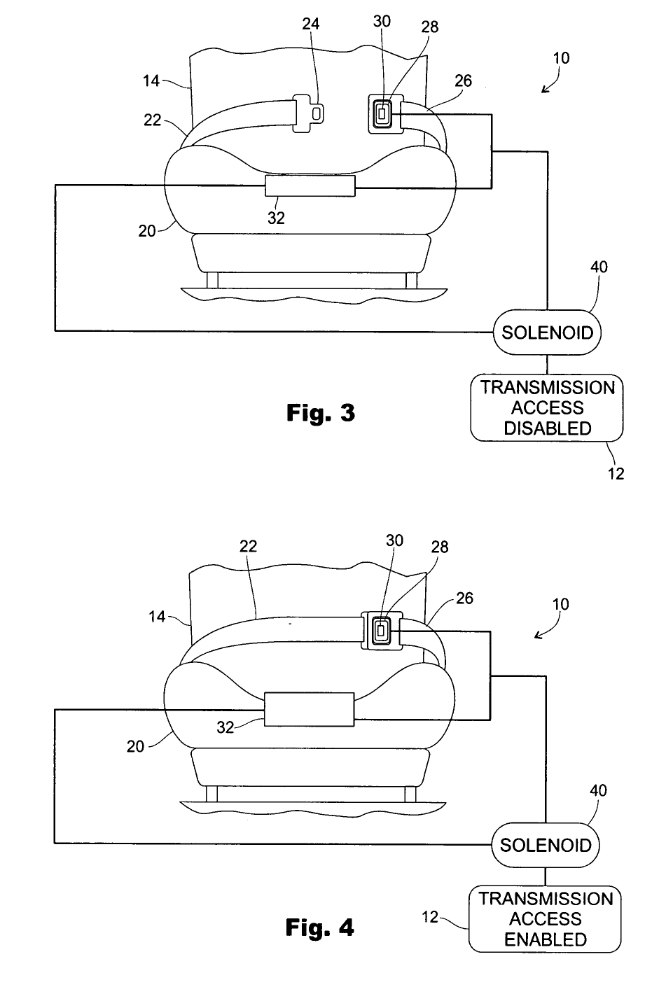

With reference to FIG. 6, a schematic representation 44 is shown setting forth the actions of one representative circuit 46 that comprises one weight sensing pad 32 and one seat buckle switch 38 electrically interconnected to each other and forming part of the circuit with the solenoid 40 for a vehicle having only one occupant. The circuit 46 shown in FIG. 6 is one portion of the entire safety system circuit, and portions of this safety system circuit are also shown in FIGS. 3 and 4. Specifically, the safety system's 10 starting action is the ignition of the vehicle and the sensing of the occupant's weight 48 by the weight sensing pad 32. If no weight 48 is sensed the microprocessor 36 keeps the circuit 46 closed and the seat buckle switch 38 for that seat buckle 28 is maintained in the open state because the seat belt 20 has not been engaged. The solenoid switch 50 also remains in the open state and thus transmission 12 access is blocked or prevented. However, if the weight sensing pad 32 senses weight, then the microprocessor 36 opens the circuit 46. The seat buckle switch 38 closes upon the occupant buckling the seat belt 20, and a signal is transmitted from the seat buckle switch 38 to the solenoid 40 that actuates the closing the solenoid switch 52 and allows access to the transmission 12 so that forward or rearward movement of the vehicle out of the park gear can occur. This circuit 46 for the safety system 10 is thus completed and disposed for transmission 12 access and engagement. The system 10 automatically resets itself after the occupant has stopped the vehicle, turned off the vehicle's engine, and unbuckled the seat belt 20.

It is to be noted that numerous modifications, alterations, and variations can be made by those skillful in the art without departing from the spirit of the invention or the scope of the invention as set forth in the appended claims.

I claim:

1. A safety system for an automotive vehicle that blocks access to the transmission of the vehicle until an occupant of a seat of the vehicle has buckled their seat belt, comprising:
a weight sensing pad disposed within the seat of the vehicle for sensing the weight of the occupant when the occupant sits in the seat;
a seat buckle switch disposed within the seat buckle of the seat belt and interconnected to the weight sensing pad, the seat buckle switch disposed in a switch open state when the seat belt is unbuckled and is disposed in a switch close state when the seat belt is buckled;
a solenoid disposed in electrical interconnection with the seat buckle switch and the transmission and having an open state that prevents access to the transmission and a closed state that allows access to the transmission;
the weight sensing pad, the seat buckle switch and the solenoid defining a seat belt safety system circuit; and
upon the weight sensing pad sensing the weight of the occupant upon the seat the weight sensing pad opens the circuit and the buckling of the seat belt by the occupant actuates the seat buckle switch to the switch closed state thereby actuating the solenoid to the closed state and thereby enabling access to the transmission so that forward or rearward movement of the vehicle can occur.

2. The safety system for an automotive vehicle of claim 1 wherein all the occupants of the seats of the automotive vehicle must have their seat belts buckled before access to the transmission is enabled so that forward or rearward movement of the vehicle can occur.

3. The safety system for an automotive vehicle of claim 2 wherein the ignition of the automotive vehicle can be turned on without the weight sensing pad sensing the weight of the occupant upon the seat and without the seat belt being buckled.
